(19) United States
(12) Patent Application Publication
(10) Pub. No.: US 2007/0160776 A1
(43) Pub. Date: Jul. 12, 2007

(54) INK COMPOSITION, DISPLAY PANEL COMPRISING THE SAME, AND MANUFACTURING METHOD THEREOF

(75) Inventors: Seong-Gyu KWON, Suwon-si (KR); Byoung-Joo KIM, Anyang-si (KR); Jang-Sub KIM, Suwon-si (KR); Yoon-Ho KANG, Yongin-si (KR); Kwang-Ho LEE, Seoul (KR); Chang-Hun KWAK, Suwon-si (KR); Jong-Soo LEE, Pyeongtak-si (KR); Hun-Hee LEE, Pyeongtak-si (KR)

Correspondence Address: CANTOR COLBURN, LLP, 55 GRIFFIN ROAD SOUTH, BLOOMFIELD, CT, 06002, US

(73) Assignees: SAMSUNG ELECTRONICS CO., LTD., Suwon-si (KR); DONGWOO FINE-CHEM CO., LTD, Iksan-si (KR)

(21) Appl. No.: 11/610,183

(22) Filed: Dec. 13, 2006

(30) Foreign Application Priority Data
Jan. 6, 2006 (KR) 10-2006-0001782

(51) Int. Cl. C09K 19/00

(52) U.S. Cl. 428/1.1

(57) ABSTRACT

An exemplary ink composition includes a polymerizable compound, a polymerization initiator, a binder, a colorant and a solvent including at least one main solvent with a boiling point of about 150° C. or lower. A display panel including the exemplary ink composition and its manufacturing method are also disclosed.

This application claims priority to Korean Patent Application No. 10-2006-5 0001782, filed on Jan. 6, 2006, and all the benefits accruing therefrom under 35 U.S.C. §119, the contents of which in its entirety are herein incorporated by reference.

### BACKGROUND OF THE INVENTION

(a) Field of the Invention

The present invention relates to an ink composition, and a display panel including the ink composition and its manufacturing method.

(b) Description of the Related Art

A liquid crystal display (“LCD”) is one of the most commonly used flat panel displays. The LCD includes a thin film transistor (“TFT”) array panel and a color filter panel with field generating electrodes formed therein. A liquid crystal layer is interposed between the TFT panel and the color filter panel. In the LCD, a voltage is applied to the field generating electrodes to orient liquid crystal molecules of the liquid crystal layer to thereby control transmittance of light that passes therethrough.

Color filters for implementing colors in the LCD include a fine pattern representing colors such as red, green and blue. Such a fine pattern of color filters is formed through a printing method, an electrodeposition method, a pigment dispersing method, or an ink jet method, for example, but is not limited thereto.

According to the printing method, ink is coated on a print plate, which is then printed to form color filters. This method does not adequately produce a fine pattern, and it is limited in application for a large-scale LCD. The electrodeposition method involves forming color filters by using an electroplating method. By using this method, color filters with good smoothness can be obtained, but their color characteristics, such as color purity, are poor.

The pigment dispersing method involves forming color filters by coating, exposing, developing and hardening a pigment composition dispersed in a photosensitive resin. The color filters obtained by this method exhibit excellent fineness and reproducibility, but the necessity for performing the processes of coating, exposing, developing and hardening for each color lengthens the manufacturing process time, and an increase in control factors between processes makes yield management difficult. In addition, as high color reproducibility (color concentration compared with National Television Systems Committee (NTSC)) is required for monitors or TVs, the film thickness should increase, thus limiting the pigment dispersing method in its application to an actual production process.

The ink jet method has been proposed to solve the problems of the above methods.

In the ink jet method, liquid ink is sprayed (jetted) to certain defined portions by using an ink jet head to implement each ink-colored image. Because a plurality of colors including red, green and blue can be colored at one time, the manufacturing process, time and cost can be considerably reduced.

However, the ink jet method is disadvantageous in that, after the liquid ink is sprayed, a drying process is performed thereon, resulting in a non-uniform thickness of the dried ink. With the non-uniform ink thickness, spectrum characteristics may differ between a central portion and an edge portion of the same pixel, causing a defective wide viewing angle or light leakage.

### BRIEF SUMMARY OF THE INVENTION

An aspect of the present invention includes improving spectrum characteristics by improving flatness of color filters.

An exemplary embodiment of the present invention provides an ink composition including a polymerizable compound, a polymerization initiator, a binder, a colorant, and a solvent including at least one main solvent with a boiling point of 150° C. or lower.

The main solvent may be contained at about 80 wt % of the total amount of the solvent.

The main solvent may include at least one selected from the group consisting of n-butyl acetate, iso-butyl acetate, iso-amyl acetate, n-amyl acetate, methyl isobutyl ketone, n-butyl alcohol, ethylene glycol ethyl ether, ethylene glycol monomethyl ether, ethylene glycol ether, ethylene glycol propyl ether, ethylene glycol isopropyl ether, ethylene glycol monomethyl ether acetate, ethylene glycol ethyl ether acetate, propylene glycol monomethyl ether, propylene glycol monomethyl ether, propylene glycol ethyl ether, propylene glycol propyl ether, propylene glycol monomethyl ether acetate, N,N-dimethyl formamide, o-xylene, and m-xylene.

The main solvent may have a vapor pressure of about 2 mmHg or higher at room temperature.

The ink composition may further include an auxiliary solvent at about 20 wt % or lower of the total amount of the solvent.

The auxiliary solvent may include at least one selected from the group consisting of ethyl-3-ethoxy propionate (“EEP”) or dipropylene glycol mono methyl ether acetate (“DPMA”).

The solvent may be contained at about 40 to about 90 wt % of the total amount of the ink composition. In addition, the ink composition may contain a polymerizable compound at about 0.1 wt % to about 50 wt %, a polymerization initiator at about 0.1 wt % to about 20 wt %, a binder at about 0.1 wt % to about 50 wt %, and a colorant at about 30 wt % to about 80 wt % with respect to the total amount of the ink composition.

The ink composition may further include an additive.

The additive may be contained at about 0.001 wt % to about 10 wt % of the total amount of the ink composition.

Another exemplary embodiment of the present invention provides a display panel including a substrate, color filters formed on the substrate and a field generating electrode formed on the color filters, wherein the color filters are formed of an ink composition containing a polymerizable compound, a polymerization initiator, a binder, a colorant and a solvent containing at least one main solvent with a boiling point of about 150° C. or lower.

The color filters may have a thickness of about 1.5 μm or less.

The color filters may have color reproducibility of about 55% or more.

The main solvent may include at least one selected from the group consisting of n-butyl acetate, iso-butyl acetate, iso-amyl acetate, n-amyl acetate, methyl isobutyl ketone, n-butyl alcohol, ethylene glycol ethyl ether, ethylene glycol monomethyl ether, ethylene glycol ether, ethylene glycol propyl ether, ethylene glycol isopropyl ether, ethylene glycol monomethyl ether acetate, ethylene glycol ethyl ether acetate, propylene glycol monomethyl ether, propylene glycol monomethyl ether, propylene glycol ethyl ether, propylene glycol propyl ether, propylene glycol monomethyl ether acetate, N,N-dimethyl formamide, o-xylene, and m-xylene, and the main solvent can be contained at about 80 wt % or greater of the total amount of the solvent.

The solvent may be contained at about 40 wt % to about 90 wt % of the total amount of the ink composition.

The display panel may contain a polymerizable compound at about 0.1 wt % to about 50 wt %, a polymerization initiator at about 0.1 wt % to 20 wt %, a binder at about 0.1 wt % to about 50 wt %, and a colorant at about 30 wt % to about 80 wt %, with respect to the total amount of a solid of the ink composition.

Still another exemplary embodiment of the present invention provides a display panel including a substrate, color filters formed on the substrate and having a thickness of about 1.5 μm or less and a field generating electrode formed on the color filters.

The color filters may have color reproducibility of about 55% or more.

Yet another exemplary embodiment of the present invention provides a method for manufacturing a display panel, the method including: forming partitions having a plurality of openings on a substrate; preparing an ink composition containing a polymerizable compound, a polymerization initiator, a binder, a colorant, and a solvent containing at least one main solvent with a boiling point of about 150° C. or lower; spraying the ink composition to the openings; drying the ink composition to form color filters; and forming electric generating electrodes on the color filters.

The main solvent may include at least one selected from the group consisting of n-butyl acetate, iso-butyl acetate, iso-amyl acetate, n-amyl acetate, methyl isobutyl ketone, n-butyl alcohol, ethylene glycol ethyl ether, ethylene glycol monomethyl ether, ethylene glycol ether, ethylene glycol propyl ether, ethylene glycol isopropyl ether, ethylene glycol monomethyl ether acetate, ethylene glycol ethyl ether acetate, propylene glycol monomethyl ether, propylene glycol monomethyl ether, propylene glycol ethyl ether, propylene glycol propyl ether, propylene glycol monomethyl ether acetate, N,N-dimethyl formamide, o-xylene, and m-xylene, and the main solvent may be contained at about 80 wt % or greater of the total amount of the solvent.

The solvent may be contained at about 40 wt % to about 90 wt % of the total amount of the ink composition.

The display panel may contain a polymerizable compound at about 0.1 wt % to about 50 wt %, a polymerization initiator at about 0.1 wt % to about 20 wt %, a binder at about 0.1 wt % to about 50 wt % and a colorant at about 30 wt % to about 80 wt % of the total amount of a solid of the ink composition.

### BRIEF DESCRIPTION OF THE DRAWINGS

Aspects, features and advantages of the present invention will be made apparent through descriptions of exemplary embodiments of the present invention with reference to the accompanying drawings, in which:

FIG. 1 is a cross-sectional view of a color filter panel according to an exemplary embodiment of the present invention;

FIGS. 2 to 7 are cross-sectional views sequentially showing a method for manufacturing the color filter panel of FIG. 1 according to another exemplary embodiment of the present invention;

FIGS. 8A to 8F are graphs showing flatness of color filters formed by spraying first to sixth ink compositions according to exemplary embodiments of the present invention; and

FIGS. 8G to 8I are graphs showing a thickness of color filters formed by spraying seventh to ninth ink compositions according to comparative examples.

### DETAILED DESCRIPTION OF THE INVENTION

The present invention now will be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, exemplary embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in detail with reference to the accompanying drawings.

An ink composition for an ink jet according to an exemplary embodiment of the present invention will be described in more detail hereinafter.

The ink composition according to the exemplary embodiment of the present invention includes a solid including a polymerizable compound, a polymerization initiator, a binder and a colorant a solvent is included for dissolving the solid.

The polymerizable compound is a compound such as a monomer or oligomer that can be polymerized by light or heat, including a compound having a carbon-carbon unsaturated bond or a carbon-carbon cyclic bond. The polymerizable compound includes, for example, 1,3-butylene glycol diacrylate, 1,4-butanedioldiacrylate, ethylene glycol diacrylate, triethylene glycol diacrylate, polyethylene glycol diacrylate, pentaerythritol tetra(metha)acrylate, dipentaerythritol diacrylate, dipentaerythritol polyacrylate, sorbitol triacrylate, bisphenol A derivative diacrylate, trimethylpropane triacrylate, methacrylate pentaerythritol tetraacrylate, dipentaerythritol pentamethacrylate, dipentaerythritol hexaacrylate, dipentaerythritol hexamethacrylate, bisphenol A type epoxy resin, bisphenol F type epoxy resin, phenol novolac type epoxy resin, and a cresol novolac type epoxy resin, and may include one or more selected from the group consisting of them.

Commercial products of such a compound sold on the market include Epicoat 1001, 1002, 1003, 1004, 1007, 1009, 1010, and 828 as a bisphenol A type of epoxy (manufactured by Yuca Shell Epoxy Co.), Epicoat 807 and 834 (manufactured by Yuca Shell Epoxy Co.) as a bisphenol F type of epoxy resin, Epicoat 152, 154, and 157H65 (manufactured by Yuca Shell Epoxy Co.), and EPPN 201 and 202 as a phenol novolac type of epoxy resin (manufactured by Nippon Kayaku Co.), EOCN-102, EOCN-103S, EOCN-104S, EOCN-1020, EOCN-1025, and EOCN-1027 (manufactured by Nippon Kayaku Co.), and Epicoat 180S75 (Yuca Shell Epoxy Co.) as a cresol novolac type of epoxy resin, and CY175, CY177, and CY179 (manufactured by CIBA-GEIGY A.G), ERL-4234, ERL-4299, ERL-4221, and ERL-4206 (manufactured by U.C.C Co.), Shodine 509 (manufactured by Showa Denko Co.), Araldite CY-182, CY-192 and CY-184 (manufactured by CIBA-GEIGY A.G), Epeakron 200 and 400 (manufactured by Dinippon Ink Kokyo Co), Epicoat 871, 872, and EP1032H60 (manufactured by Yuca Shell Epoxy Co.), and ED-5661 and ED-5662 (manufactured by Cellanise coating Co.) as a cyclic aliphatic epoxy resin, and Epicoat 190P and 191P (manufactured by Yuca Shell Epoxy Co.) and Eporite 100MF (manufactured by Kyoesha Eushi Kakaku Kokyo Co.), and Epiol TMP (manufactured by Nippon Youshi Co.) as aliphatic polyglycidyl ether. Products of an oxetane compound include OXT-121 (manufactured by Donga Synthetics Co.), OXT-221 (Donga Synthetics Co.), and PNOX-1009, etc.

The polymerizable compound is contained at about 0.1 wt % to about 50 wt % of the total amount of a solid of the ink composition, preferably at about 1 wt % to about 45 wt %, and more preferably at about 5 wt % to about 40 wt %.

The polymerization initiator can be a photo-polymerization initiator or a thermal-polymerization initiator. Preferably, the photo-polymerization initiator includes at least one or more kinds of acetophenone-based compounds. The acetophenone-based compounds may include, for example, a diethoxy acetophenone, 2-methyl-2-monopolyno-1-(4-methylthiophenyl)propan-1-on, 2-hydroxy-2-methyl-1-phenylpropan-1-on, benzyldimethylketone, 2-hydroxy-2-methyl-1-[4-(2-hydroxyethoxy)phenyl]propan-1-on, 1-hydroxycyclohexylphenylketone, 2-hydroxy-2-methyl-1-[4-(1-methylvinyl)phenyl]propan-1-on, etc., of which 2-methyl-2-monopolyno-1-(4-methyltiophenyl)propan-1-on is preferred. The photo-polymerization initiator may include, for example, a benzoin-based compound, a benzophenone-based compound, a thioxanthone-based compound, or a triazine-based compound.

The benzoin-based compound may include, for example, benzoin, benzoin methyl ether, benzoin ethyl ether, benzoin isopropyl ether, benzoin isobutyl ether, etc., and the benzophenone-based compound may include benzophenone, o-benzoylbenzoic acid methyl, 4-phenylbenzophenone, 4-benzoyl-4′-methyl diphenyl sulfide, 3,3′,4,4′-tetra(t-butylperoxycarbonyl)benzophenone, 2,4,6-trimethyl benzophenone, etc. The thioxanthone-based compound may include, for example, 2-isopropylthioxanthone, 4-isopropylthioxanthone, 2,4-diethylthioxanthone, 2,4-dichlorothioxanthone, 1-chloro-4-propoxythioxanthone, etc., and the triazine-based compound includes 2,4-trichloromethyl-(piperonyl)-6-triazine, 2,4-bis(trichloromethyl)-6-(4-methoxyphenyl)-1,3,5-triazine, 2,4-bis(trichloromethyl)-6-(4-methoxynaphthyl)-1,3,5-triazine, 2,4-bis(trichloromethyl)-6-(4-methoxystyryl)-1,3,5-triazine, 2,4-bis(trichloromethyl)-6-2-(5-methylfuran-2-yl)ethenyl)-1,3,5-triazine, 2,4-bis(trichloromethyl)-6-2-(furan-2-yl)ethenyl)-1,3,5-triazine, 2,4-bis(trichloromethyl)-6-2-(4-diethylamino-2-methylphenyl)ethynyl)-1,3,5-triazine, 2,4-bis(trichloromethyl)-6-2-(3,4-dimethoxyphenyl)ethynyl)-1,3,5-triazine, etc.

The photo-polymerization initiator may include, for example, 2,4,6-trimethylbenzoyl diphenylphosphine oxide, 2,2′-bis(o-chlorophenyl)-4,4′,5,5′-tetraphenyl-1,2′-biimidazol, 10-butyl-2-chloroacridone, 2-ethylanthraquinone, 9,10-phenanthrenequinone, camphorquinone, methyl phenylglyoxylate, and a titanocene compound, etc. In addition, the photo-polymerization initiator may include, for example, an onium salt such as 4-hydroxyphenyldimethyl sulphonium p-toluensulfonate, 4-hydroxyphenyl dimethyl sulphonium hexafluoroantimonate, 4-acetoxyphenyl dimethyl sulphonium p-toluene sulfonate, 4-acetoxyphenyl methyl benzyl sulphonium hexafluoroantimonate, triphenyl sulphonium p-toluene sulfonate, triphenyl sulphonium hexafluoro antimonate, diphenyl iodonium p-toluensulfonate and diphenyl iodinium hexafluoroantimonate, nitrobenzyl tosilate, and benzointosilate, etc.

The thermal-polymerization initiator may include, for example, an organic oxide such as cumenehydroperoxide, diisopropylbenzeneperoxide, di-t-butylperoxide, laurylperoxide, benzoylperoxide, t-butylperoxy isopropylcarbonate, t-butylperoxy-2-ethylhexanoate, t-amylperoxy-2-hexanoate, etc., or an azo compound such as 2,2′-azobis(isobutyronitrile, 1,1′-azobis(cyclohexanecarbonitrile), 1,1′-azobis(cyclohexane carbonitrile), 2,2′azobis(2,4′-dimethylvaleronitrile), dimethyl 2,2′-azobis(2-methylpropionate), etc., and may include one kind or two or more kinds selected from them.

In addition, the thermal-polymerization initiator may include, for example, an onium salt such as sulphonium salt, benzothiazonium salt, ammonium salt, and phosphonium salt, etc., of which sulphonium salt and benzothiazonium salt are preferred.

The sulphonium salt may include, for example, an alkyl sulphonium salt such as 4-acetophenyl dimethyl sulphonium hexafluoroantimonate, 4-acetoxyphenyl dimethyl sulphonium hexafluoroarsenate, dimethyl-4-(benzyl oxycarbonyloxy)phenyl sulphonium hexafluoroantimonate, dimethyl-4-(benzoyloxy)phenyl sulphonium hexafluoroantimonate, dimethyl-4-(benzoyloxy)phenyl sulphonium hexafluoroarsenate, dimethyl-3-chloro-4-acetoxy phenyl sulphonium hexafluoroantimonate, etc., a benzyl sulphonium salt such as benzyl-4-hydroxy phenyl methyl sulphonium hexafluoroantimonate, benzyl-4-hydroxy phenyl methyl sulphonium hexafluorophosphate, 4-acetoxyphenyl benzyl methyl sulphonium hexafluoroantimonate, benzyl-4-methoxy phenyl methyl sulphonium hexafluoroantimonate, benzyl-2-methyl-4-hydroxy phenyl methyl sulphonium hexafluoroantimonate, benzyl-3-chloro-4-hydroxy phenyl methyl sulphonium hexafluoroarsenate, 4-methoxy benzyl-4-hydroxy phenyl methyl sulphonium hexafluorophosphate, etc., a dibenzyl sulphonium salt such as dibenzyl-4-hydroxy phenyl sulphonium hexafluoroantimonate, dibenzyl-4-hydroxyphenyl sulphonium hexafluorophosphate, 4-acetoxyphenyl dibenzyl sulphonium hexafluoroantimonate, dibenzyl-4-methoxy phenyl sulphonium hexafluoroantimonate, dibenzyl-3-chloro-4-hydroxyphenyl sulphonium hexafluoroarsenate, dibenzyl-3-methyl-4-hydroxy-5-tert-butyl phenyl sulphonium hexafluoroantimonate, benzyl-4-methoxybenzyl-4-hydroxy phenyl sulphonium hexafluorophosphate, etc., and a substituted benzyl sulphonium salt such as p-chloro benzyl-4-hydroxyphenylmethyl sulphonium hexafluoroantimonate, p-nitrobenzyl-4-hydroxyphenyl methyl sulphonium hexafluoroantimonate, p-chlorobenzyl-4-hydroxy phenyl methyl sulphonium hexafluorophosphate, p-nitrobenzyl-3-methyl-4-hydroxy phenyl methyl sulphonium hexafluoroantimonate, 3,5-dichlorobenzyl-4-hydroxy phenyl methyl sulphonium hexafluoroantimonate, o-chlorobenzyl-3-chloro-4-hydroxy phenyl methyl sulphonium hexafluoroantimonate, etc., of which N-benzylpyrazinium hexafluoro antimonate is preferred.

The photo-polymerization initiator or the thermal-polymerization initiator can be selected one kind or two or more kinds thereof. The initiator can be contained at about 0.1 wt % to about 20 wt % of the total amount of a solid of the ink composition, preferably at about 0.2 wt % to about 15 wt %, and more preferably at about 0.5 wt % to about 10 wt %.

The binder can be selected an acryl-based copolymer. The acryl-based copolymer may include, for example, a carboxyl group-containing monomer and a copolymer of a different monomer that can be copolymerized with it.

The carboxyl group-containing monomer can be unsaturated carboxyl acid. The unsaturated carboxyl acid may include, for example, acrylic acid, methacrylic acid, crotonic acid, α-chloro acrylic acid, cinnamic acid, malic acid, fumaric acid, itaconic acid, citraconic acid, mesaconic acid, maleic acid anhydride, itacoonic acid anhydride, citraconic acid anhydride, mono(2-methacryloyloxyalkyl)ester, succinic acid mono(2-acryloyloxyethyl), succinic acid mono(2-methacryloyloxyethyl), phthalic acid mono(2-acryloyloxyethyl), phthalic acid mono(2-methacryloyloxyethyl), ω-carboxypolycaprolactone monoacrylate, and ω-carboxypolycaprolactone monomethacrylate, etc., and can be one kind or two or more kinds selected among them.

The monomer that can be copolymerized with the carboxyl group-containing monomer may include an aromatic vinyl compound such as styrene, α-methyl styrene, o-vinyl toluene, m-vinyl toluene, p-vinyl toluene, p-chlorostyrene, o-methoxy styrene, m-methoxy styrene, p-methoxy styrene, o-vinyl benzyl methyl ether, m-vinyl benzyl glycidyl ether, p-vinyl benzyl methyl ether, o-vinyl benzyl glycidyl ether, m-vinyl benzyl glycidyl ether, p-vinyl benzyl glycidyl ether, and inden, etc.; an unsaturated carboxylic acid ester type such as methyl acrylate, methyl methacrylate, ethyl acrylate, ethyl methacrylate, n-propyl acrylate, n-propyl methacrylate, iso-propyl acrylate, iso-propyl methacrylate, n-butyl acrylate, n-butyl methacrylate, iso-butyl acrylate, iso-butyl methacrylate, sec-butyl acrylate, sec-butyl methacrylate, t-butyl acrylate, t-butyl methacrylate, 2-hydroxy ethyl acrylate, 2-hydroxy ethyl methacrylate, 2-hydroxy propyl acrylate, 2-hydroxy propyl methacrylate, 3-hydroxy propyl acrylate, 3-hydroxy propyl methacrylate, 2-hydroxy butyl acrylate, 2-hydroxy butyl methacrylate, 3-hydroxy butyl acrylate, 3-hydroxy butyl methacrylate, allyl acrylate, allylmethacrylate, benzyl acrylate, benzyl methacrylate, cyclohexyl acrylate, cyclohexyl methacrylate, phenyl acrylate, phenyl methacrylate, 2-methoxy ethyl acrylate, 2-methoxy ethyl methacrylate, 2-phenoxy ethyl acrylate, 2-phenoxy ethyl methacrylate, methoxy diethylene glycol acrylate, methoxy diethylene glycol methacrylate, methoxy triethylene glycol acrylate, methoxy triethylene glycol methacrylate, methoxy propylene glycol acrylate, methoxy propylene glycol methacrylate, methoxy dipropylene glycol acrylate, methoxy dipropylene glycol methacrylate, isophonyl acrylate, isophonyl methacrylate, dicyclopentadienyl acrylate, dicyclopentadienyl methacrylate, 2-hydroxy-3-phenoxypropyl acrylate, 2-hydroxy-3-phenoxy propyl methacrylate, glycerol monoacrylate, and glycerol monomethacrylate, etc.; an unsaturated carboxyl acid amino alkyl ester type such as 2-amino ethyl acrylate, 2-amino ethyl methacrylate, 2-dimethyl amino ethyl acrylate, 2-dimethyl amino ethyl methacrylate, 2-amino propyl acrylate, 2-amino propyl methacrylate, 2-dimethyl amino propyl acrylate, 2-dimethyl amino propyl methacrylate, 3-amino propyl acrylate, 2-dimethyl amino propyl methacrylate, 3-amino propyl acrylate, 3-amino propyl methacrylate, 3-dimethyl amino propyl acrylate, and 3-dimethyl amino propyl methacrylate, etc.; an unsaturated carboxyl acid glycidyl ester type such as glycidyl acrylate and glycidyl methacrylate, etc.; vinyl acetate, vinyl propionate, vinyl butyrate, and vinyl benzoate, etc.; an unsaturated ether such as vinyl methyl ether, vinyl ethyl ether, and allyl glycidyl ether, etc.; an acrylonitrile compound such as acrylonitrile, metha acrylonitrile, α-chloro acrylonitrile, vinylidene cyanide; an unsaturated amide type such as acryl amide, methacrylamide, α-chloro acrylamide, N-2-hydroxy ethyl acrylamide, and N-2-hydroxy ethyl methacrylamide, etc.; an unsaturated imide type such as maleimide, N-phenyl maleimide, and N-cyclo hexyl maleimide, etc.; an aliphatic conjugated diene type such as 1,3-butadiene, isoprene, and chloroprene, etc.; and a macro monomer having a mono acryloyl group or a mono methacryloyl group at an end of polymer molecule chains of polystyrene, polymethyl acrylate, polymethyl methacrylate, poly-n-butyl acrylate, poly-n-butyl acrylate, poly-n-butyl methacrylate, polysiloxane, and may include one type or two or more types selected from them. The acryl-based copolymer may include, for example, a (metha)acrylic acid/methyl(metha)acrylate copolymer, a (metha)acrylic acid/benzyl(metha)acrylate copolymer, a (metha)acrylic acid/2-hydroxy ethyl(metha) acrylate/benzyl(metha)acrylate copolymer, a (metha)acrylic acid/methyl(metha) acrylate/polystyrene macromonomer copolymer, a (metha)acrylic acid/methyl(metha)acrylate/polymethyl(metha)acrylate macromonomer copolymer, a (metha)acrylic acid/benzyl(metha) acrylate/polystyrene macromonomer copolymer, a (metha)acrylic acid/benzyl(metha)acrylate/polymethyl(metha)acrylate macromonomer copolymer, a (metha)acrylic acid/2-hydroxy ethyl(metha)acrylate/benzyl(metha)acrylate/polystyrene macromonomer copolymer, a (metha)acrylic acid/2-hydroxy ethyl(metha)acrylate/benzyl(metha)acrylate/polymethyl(metha)acrylate macromonomer copolymer, a (metha)acrylic acid/styrene/benzyl(metha)acrylate/N-phenylmaleimide copolymer, a (metha)acrylic acid/succinic acid mono (2-acryloyloxyethyl)/styrene/benzyl(metha)acrylate/N-phenylmaleimide copolymer, a (metha)acrylic acid/ succinic mono (2-acryloyloxyethyl)/styrene/allyl(metha)acrylate/N-phenylmaleimide copolymer, or a (metha)acrylic acid/benzyl(metha)acrylate/N-phenylmaleimide/styrene/glycerol mono(metha)acrylate copolymer, etc. Of them, a methyl(metha)acrylic acid/methyl(metha)acrylate copolymer, a methyl(metha)acrylic acid/methyl(metha)acrylate/styrene copolymer, a methyl(metha)acrylic acid/methyl(metha)acrylate/dicyclodecane copolymer, and a methyl(metha)acrylic acid/benzylmethyl(metha)acrylate copolymer are preferred.

The binder may have a polystyrene reduced weight average molecular weight of about 5,000 to about 50,000, and preferably about 8,000 to about 30,000. The binder may be contained at about 0.1 wt % to about 50 wt % with respect to the total amount of the solid of the ink composition, preferably at about 1 wt % to about 40 wt %, and more preferably at about 5 wt % to about 30 wt %.

The colorant may include an organic pigment or an inorganic pigment. Among compounds classified into pigments in a color index (published by the Society of Dyers and Colorists), the organic pigment can be, for example, a yellow pigment such as C.I. pigment yellow 1, C.I. pigment yellow 3, C.I. pigment yellow 12, C.I. pigment yellow 13, C.I. pigment yellow 14, C.I. pigment yellow 15, C.I. pigment yellow 16, C.I. pigment yellow 17, C.I. pigment yellow 20, C.I. pigment yellow 24, C.I. pigment yellow 31, C.I. pigment yellow 53, C.I. pigment yellow 83, C.I. pigment yellow 86, C.I. pigment yellow 93, C.I. pigment yellow 94, C.I. pigment yellow 109, C.I. pigment yellow 110, C.I. pigment yellow 117, C.I. pigment yellow 125, C.I. pigment yellow 128, C.I. pigment yellow 137, C.I. pigment yellow 138, C.I. pigment yellow 139, C.I. pigment yellow 147, C.I. pigment yellow 148, C.I. pigment yellow 150, C.I. pigment yellow 153, C.I pigment yellow 154, C.I. pigment yellow 166, C.I. pigment yellow 173, C.I. pigment yellow 194, and C.I. pigment yellow 214, etc; an orange pigment such as C.I. pigment orange 13, C.I. pigment orange 31, C.I. pigment orange 36, C.I. pigment orange 38, C.I. pigment orange 40, C.I. pigment orange 42, C.I. pigment orange 43, C.I. pigment orange 51, C.I. pigment orange 55, C.I. pigment orange 59, C.I. pigment orange 61, C.I. pigment orange 64, C.I. pigment orange 65, C.I. pigment orange 71, and C.I. pigment orange 73, etc.; a red pigment such as C.I. pigment red 9, C.I. pigment red 97, C.I. pigment red 105, C.I. pigment red 122, C.I. pigment red 123, C.I. pigment red 144, C.I. pigment red 149, C.I. pigment red 166, C.I. pigment red 168, C.I. pigment red 176, C.I. pigment red 177, C.I. pigment red 180, C.I. pigment red 192, C.I. pigment red 209, C.I. pigment red 215, C.I. pigment red 216, C.I. pigment red 224, C.I. pigment red 242, C.I pigment red 254, C.I. pigment red 264, and C.I. pigment red 265, etc.; a blue pigment such as C.I. pigment blue 15, C.I. pigment blue 15:3, C.I. pigment blue 15:4, C.I. pigment blue 15:6, and C.I. pigment blue 60, etc; a violet pigment such as C.I. pigment violet 1, C.I. pigment violet 19, C.I. pigment violet 23, C.I. pigment violet 29, C.I. pigment violet 32, C.I. pigment violet 36, and C.I. pigment violet 38, etc.; a green pigment such as C.I. pigment green 7, and C.I. pigment green 36, etc.; a brown pigment such as C.I. pigment brown 23, and C.I. pigment brown 25, etc.; or a black pigment such as C.I. pigment black 1, and C.I. pigment black 7, etc. Of them, at least one type selected from the group consisting of C.I. pigment red 254, C.I. pigment red 209, C.I. pigment red 242, and C.I. pigment red 177 is preferably contained to form a red pixel, at least one type selected from the group consisting of C.I. pigment green 36, C.I. pigment green 7, C.I. pigment yellow 150, and C.I. pigment yellow 138 is preferably contained to form a green pixel, and at least one type selected from the group consisting of C.I. pigment blue 15:3, C.I. pigment blue 15:6, and pigment violet 23 is preferably contained to form a blue pixel.

The inorganic pigment may include, for example, titanium dioxide, titanium black, and carbon black, etc., and may include one type or two or more types of the above.

The organic pigment or the inorganic pigment may undergo resin processing, a surface treatment using a pigment derivative, etc., which contains an acid group or a base group, graft processing on a pigment surface with a polymer compound, atomization processing according to sulfuric acid atomization, cleaning processing with an organic solvent or water to remove an impurity, or processing for removing an ionic impurity according to an ionic bonding method, as necessary. Preferably, the pigment used as the colorant has a uniform particle diameter, for which a method for dispersing the pigment by using a surface active agent as a pigment dispersion agent is used.

The colorant may be contained at about 30 wt % to about 80 wt % of the total amount of the solid of the ink composition, preferably at about 33 wt % to about 75 wt %, and more preferably at about 35 wt % to about 70 wt %.

The ink composition according to the exemplary embodiment of the present invention may further include an additive in addition to the above-described ingredients. The additive may be at least one or more selected from the group consisting of a surfactant, a moistening agent, a silane coupling agent, a filler, an ultraviolet ray absorption agent and a coagulant preventing agent. Preferably, the additive can be contained at about 0.001 wt % to about 10 wt % of the total amount of the solid of the ink composition, and preferably at about 0.002 wt % to about 5 wt %.

As the surfactant, a silicon-based surfactant, a fluorine-containing surfactant, a silicon-based surfactant having fluorine atoms, and their mixture, etc., may be used. The silicon-based surfactant may be, for example, a surfactant having a siloxane bond. The commercial products sold on the market include Torey silicon DC3PA, Torey silicon SH7PA, Torey silicon DC11PA, Torey silicon SH21PA, Torey silicon SH28PA, Torey silicon 29SHPA, Torey silicon SH30PA, and polyether modified silicon oil SH8400 (manufactured by Torey Silicon Co. Ltd.), KP321, KP322, KP323, KP324, KP326, KP340, and KP341 (manufactured by Shin-Etsu Silicon Co. Ltd.), and TSF400, TSF401, TSF410, TSF4300, TSF4440, TSF4445, TSF-4446, TSF4452, and TSF4460 (manufactured by GE Toshiba Silicon Co. Ltd.). The fluorine-containing surfactant may include a surfactant having fluorocarbon chains. Substantially, commercial products of the fluorine surfactant may include, for example, Fluorinate, FC430, Fluorinate FC431 (manufactured by Smitomo 3M Co. Ltd.), Megapack F142D, Megapack F171, Megapack F172, Megapack F173, Megapack F177, Megapack F183, and Megapack R30 (manufactured by Dinippon Ink Kakakukokyo Co. Ltd.), Eftop EF301, Eftop EF303, Eftop EF351, and Eftop EF352 (manufactured by Shinakitakasei Co. Ltd.), Surfron S381, Surfron S382, Surfron SC101, and Surfron SC105 (manufactured by Asahigaras Co. Ltd), E5844 (manufactured by Dikinfine Chemical Kenkyusho Co. Ltd.), BM-1000 and BM-1100 (manufactured by BMChemie Co. Ltd.), etc. The silicon-based surfactant having fluorine atoms may be, for example, a surfactant having siloxane bonds and fluorocarbon chains. Substantially, products of the silicon-based surfactant may include, for example, Megapack R08, Megapack BL20, Megapack F475, Megapack F477 and Megapack F443 (manufactured by Dinippion ink Kakakukokyo. Co. Ltd.).

As the moistening agent, there may be, for example, glycerine, diethyleneglycol, and ethylenglycol, etc., and one or more selected from the above may be included.

The silane coupling agent may be, for example, [symbol] aminopropyltriethoxysilane, [symbol] mercaptopropyltrimethoxysilane, and [symbol] methacryloxypropyltrimethoxysilane, etc., and its commercial products include SH6062, SZ6030 (manufactured by Toray-Dow Corning Silicon Co., Ltd.), and KBE903 and KBM803 (manufactured by Shin-Etsu silicon Co., Ltd.).

As the filler, particulates of glass or alumina may be used.

The ultraviolet ray absorption agent may include, for example, a benzotriazole-based compound such as 2-(2-hydroxy-3-t-butyl-5-methylphenyl)-5-chlorobenzotriazole, etc., a benzophenone-based compound such as 2-hydroxy-4-octyloxybenzophenone, etc., a benzoate-based compound such as 2,4,-di-t-butylphenyl-3,5-di-t-butyl-4-hydroxybenzoate, etc., and a triazine-based compound such as 2-(4,6-diphenyl-1,3,5-triazin-2-yl)-5-hexyloxyphenol, etc.

The coagulant preventing agent may be, for example, polyacrylamide. The solvent may be a polar solvent or a non-polar solvent that may dissolve an ingredient (referred to hereinafter as a ‘solid’) excluding the solvent contained in the ink composition, without being particularly limited. For example, the solvent may be an ether, aromatic hydrocarbon, ketone, alcohol, ester, or amide, etc.

The ether may include, for example, tetrahydrofuran, tetrahydropyrane, 1,4-dioxans, ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, diethylene glycol monobutyl ether, diethylene glycol dimethyl ether, diethylene glycol diethyl ether, diethylene glycol dipropyl ether, diethylene glycol dibutyl ether, propylene glycol monomethyl ether acetate, propylene glycol monoethyl ether acetate, propylene glycol monopropyl ether acetate, methyl cellosolve acetate, ethyl cellosolve acetate, ethyl carbitol acetate, butyl carbitol acetate, propylene glycol methyl ether acetate, methoxy butyl acetate, methoxy pentyl acetate, anisole, phenetole, methylanisole, etc. The aromatic hydrocarbons may include, for example, benzene, toluene, xylene, and mesitylene, etc. The ketones may include, for example, acetone, 2-butanone, 2-heptanone, 3-heptanone, 4-heptanone, 4-methyl-2-pentanone, cyclopentanone, and cyclohexanone, etc.

The alcohols may include, for example, methanol, ethanol, propanol, butanol, hexanol, cyclohexanol, ethyleneglycol, glycerin, etc. The esters may include, for example, ethyl acetate, n-butyl acetate, isobutyl acetate, amyl formate, isoamyl acetate, isobutyl acetate, butyl propionate, isopropyl butyrate, ethyl butyrate, butyl butyrate, alkyl esters, methyl lactate, ethyl lactate, methyl oxyacetate, ethyl oxyacetate, butyl oxyacetate, methyl methoxy acetate, ethyl methoxy acetate, butyl methoxy acetate, methyl ethoxy acetate, ethyl ethoxy acetate, methyl 3-oxypropionate, ethyl 3-oxypropionate, methyl 3-methoxy propionate, ethyl 3-methoxy propionate, methyl 3-ethoxy propionate, ethyl 3-ethoxy propionate, methyl 2-oxypropionate, ethyl 2-oxypropionate, propyl 2-oxypropionate, methyl 2-methoxy propionate, ethyl 2-methoxy propionate, propyl 2-methoxy propionate, methyl 2-ethoxy propionate, ethyl 2-ethoxy propionate, methyl 2-oxy-2-methyl propionate, ethyl 2-oxy-2-methyl propionate, methyl 2-methoxy-2-methyl propionate, ethyl 2-ethoxy-2-methyl propionate, methyl pyruvate, ethyl pyruvate, propyl pyruvate, methyl acetoacetate, ethyl acetoacetate, methyl 2-oxobutanoate, ethyl 2-oxobutanoate, 3-methoxy butyl acetate, 3-methyl-3-methoxy butyl acetate, and [symbol] butyl olactone, etc. The amides may include, for example, N,N-dimethylformamide and N,N-dimethylacetamide, etc. Other solvents may include N-methyl pyrrolidone and dimethyl sulfoxide, etc. Particularly, the ink composition of the present invention includes a solvent with a low boiling point, and preferably a solvent with a boiling point of about 150° C. or lower, as a main solvent.

The main solvent may include, for example, at least one selected from the group consisting of n-butyl acetate, isobutyl acetate, isoamyl acetate, n-amyl acetate, methyl isobutyl ketone, n-butyl alcohol, ethylene glycol ethyl ether, ethylene glycol monomethyl ether, ethylene glycol ether, ethylene glycol propyl ether, ethylene glycol isopropyl ether, ethylene glycol monomethyl ether acetate, ethylene glycol ethyl ether acetate, propylene glycol monomethyl ether, propylene glycol ethyl ether, propylene glycol propyl ether, propylene glycol monomethyl ether acetate (“PGMEA”), N,N-dimethyl formamide, o-xylene, and m-xylene, and may include one or two or more types selected from the group. The main solvent may be contained at about 80 wt % or more with respect to the total amount of the solvent, preferably it can be contained at about 45 wt % to about 88 wt %, and more preferably it can be contained at about 50 wt % to about 85 wt %.

The ink composition may include both the main solvent and an auxiliary solvent. As the auxiliary solvent, any selected from the above-described solvents, except one selected as the main solvent, may be used, and the auxiliary solvent may be contained at about 20 wt % or less with respect to the total amount of the solvent. In the present invention, the main solvent and the auxiliary solvent may be contained in the ratio of 80-100:20-0, preferably at 85-95:15-5, and more preferably at 86-94:14-6. Preferably, propylene glycol monomethyl ether acetate (“PGMEA”) can be used as the main solvent and ethyl-3-ethoxypropionate (“EEP”) and dipropylene glycol monomethyl ether acetate (“DPMA”) can be used as the auxiliary solvent. In this manner, in the present invention, the solvent with the boiling point of about 150° C. or lower is used as the main solvent.

The use of the solvent with the low boiling point can lower viscosity of the ink, reduce the amount of sprayed ink, and reduce a thickness of a film remaining after a drying process. In this case, color reproducibility may be obtained by increasing the content of a colorant. For example, in the prior art, a layer is formed with a thickness of about 1.81 μm to about 2.0 μm to have color reproducibility of 72.6%, but in the present invention, the same color reproducibility can be obtained by forming the layer with a thickness of merely about 1.3 μm to about 1.5 μm. Reducing the thickness of the layer can weaken the repellant power with the partitions that defined the ink, so the flatness of the layer can be enhanced.

In addition, the solvent with a low boiling point has high vapor pressure and weak inter-molecular cohesive force on the ink surface, thus preventing the ink molecules from becoming coagulated to make a spherical form. Accordingly, by forming the layer such as the color filters with the above-described ink composition, a difference of a thickness between a central portion and an edge portion can be reduced, thus preventing a defective viewing angle or light leakage.

In addition, by using the solvent with the low boiling point, an ink remnant around a discharge hole of an ink jet nozzle can form an air inflow preventing layer by itself, preventing an inflow of air into the nozzle, so the ink spraying power can be improved.

A display panel for the LCD using the above-described ink composition will now be described.

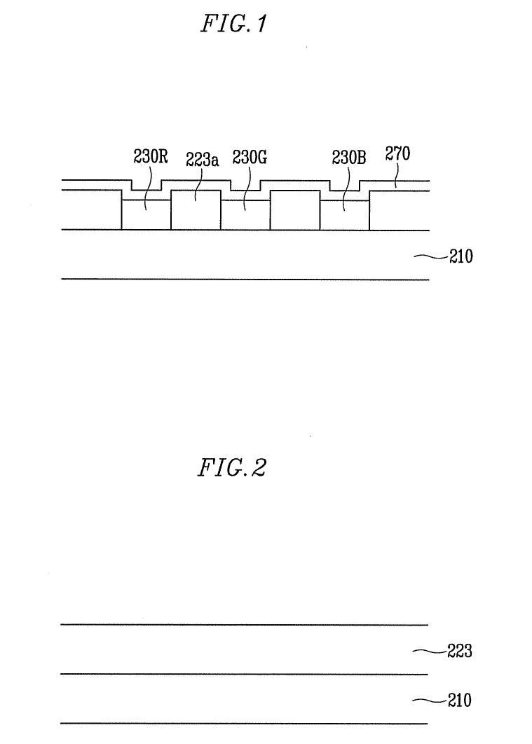

FIG. 1 is a cross-sectional view of a color filter panel according to an exemplary embodiment of the present invention.

As shown in FIG. 1, the color filter panel is constructed such that a plurality of light blocking members 223a called black matrixes are formed separately at certain intervals on a insulating substrate 210. Color filters 230R, 230G and 230B are formed between the light blocking members 223a. The color filters 230R, 230G and 230B are formed with a relatively small thickness of about 1.5 μm or smaller according to the ink jet method. In the exemplary embodiment of the present invention, because the color filters 230R, 230G and 230B are formed with the relatively small thickness compared with the prior art, the repellant power with the light blocking members 223a can be reduced to obtain better flatness of the color filters. In order to prevent degradation of the color reproducibility with the relatively low thickness of the color filters, the amount of a colorant increases to about 30 wt % to about 80 wt % with respect to the total amount of a solid of the ink composition, whereby the color reproducibility (color gamut) can be sustained at about 55% or more.

A common electrode 270 is formed on the light blocking member 223a and the color filters 230R, 230G and 230B. An overcoat (not shown) may be formed at a lower portion of the common electrode 270 in order to planarize the light blocking members 223a and the color filters 230R, 230G and 230B.

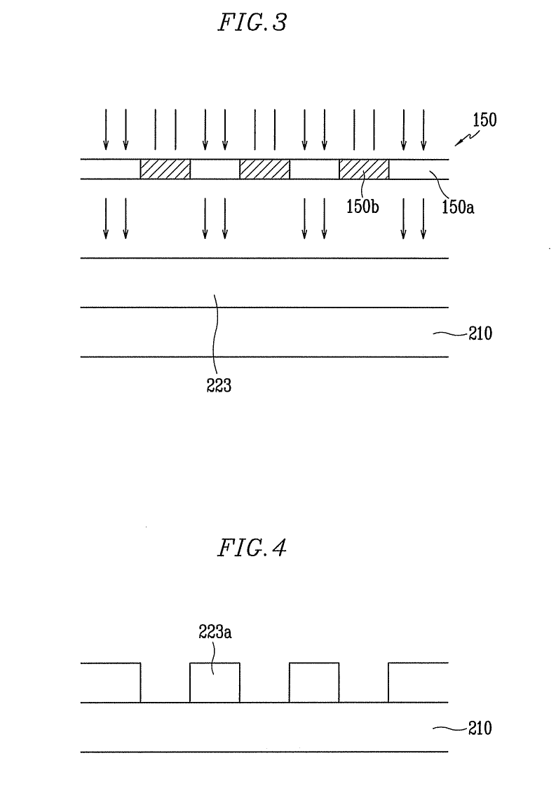

The method for manufacturing the color filter panel in FIG. 1 will be described in more detail with reference to FIGS. 1 to 7. FIGS. 2 to 7 are cross-sectional views sequentially showing a method for manufacturing the color filter panel of FIG. 1 according to the exemplary embodiment of the present invention.

First, with reference to FIG. 2, a negative photoresist film 223 is formed on the substrate 210. Next, with reference to FIG. 3, the photoresist film 223 is exposed with light of about 350 nm to about 440 nm by using a mask 150 with light transmission portions 150a and light blocking portions 150b, on which post-baking is then performed at a temperature of about 100° C. to about 130° C. for about 60 seconds to about 120 seconds. In this case, the portions 223a of the photoresist film 223 exposed through the mask 150 remain through a developing process (to be described) and portions 223b of the photoresist film 223 are removed through the developing process.

With reference to FIG. 4, the portions 223a of the photoresist film remaining after the portions 223a of the photoresist film 223 are developed by using a 2.38% tetramethylammoniumhydroxide (TMAH) solution are cured (e.g., thermoset) to form a plurality of light blocking members 223a. The light blocking members 223a serve as partitions.

Subsequently, as shown in FIG. 5, ink jet equipment is disposed above the substrate 210 with the light blocking members 223a formed thereon. The ink jet equipment includes a main body (not shown), an ink jet head 51, nozzles 52 and an ink composition, which is sprayed from the nozzles 52. The nozzles 52 are disposed between the light blocking members 223, and control spray precision and an amount of spraying.

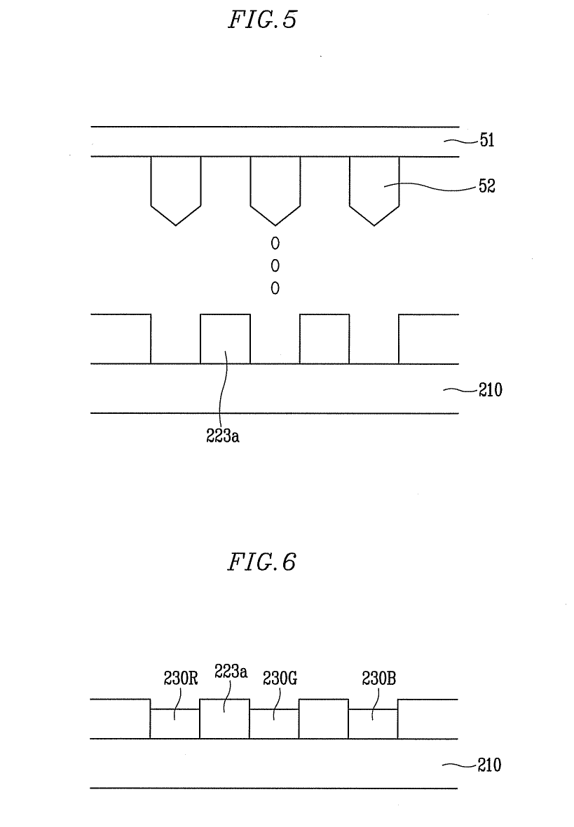

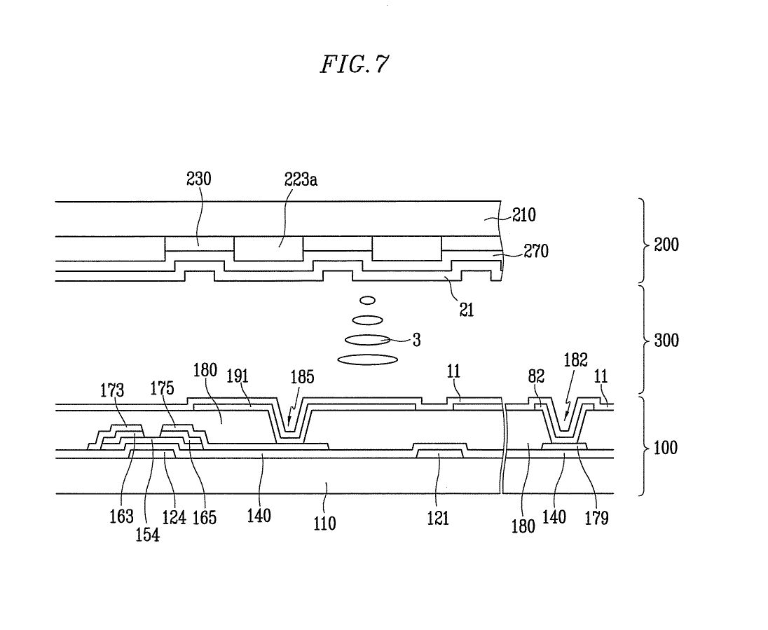

With reference to FIG. 6, the color filters 230R, 230G and 230B are formed between the light blocking members 223a.

Referring back to FIG. 1, the common electrode 270 is formed on the light blocking members 223a and the color filters 230R, 230G and 230B, and an alignment layer (not shown) is formed on the common electrode 270. Before the common electrode 270 is formed, an overcoat (not shown) may be additionally formed to planarize the light blocking members 223a and the color filters 230R, 230G and 230B.

With reference to FIG. 7, the fabricated color filter panel 200 faces a thin film transistor (“TFT”) array panel 100. The TFT array panel 100 includes a gate line 121 formed on an insulating substrate 110, a gate electrode 124, a gate insulating layer 140 formed on the gate line 121, a semiconductor 154 formed at an upper portion of the gate electrode 124, ohmic contacts 163 and 165 formed on the semiconductor 154, a source electrode 173 and a drain electrode 175 facing each other centering on the semiconductor 154, a passivation layer 180 having a plurality of contact holes 185 and 182, a pixel electrode 191 connected with the drain electrode 175 via the contact hole 185, an auxiliary ohmic contact (contact member) 82 connected with an end portion 179 of a data line via the contact hole 182, and an alignment layer 11 formed thereon. A liquid crystal layer 300 including a plurality of liquid crystals 3 is injected between the TFT array panel 100 and the color filter array panel 200, thereby completing an LCD.

### EXPERIMENTAL EXAMPLE

Characteristics of the ink composition according to the exemplary embodiment of the present invention were checked and compared with a comparative example. In Table 1, (A-1) to (F-1) are ingredients of the ink composition. Specifically, the (A-1) to (A-3) are colorants, (B-1) is a binder, (C-1) is a polymerizable compound, (D-1) is a polymerization initiator, (E-1) to (E-3) are solvents, and (F-1) is a surfactant. (A-1) Red colorant: C.I. pigment red 254/C.I. pigment red 177/dispersion agent (A-2) Green colorant: C.I. pigment green 36/C.I. pigment yellow 150/dispersion agent (A-3) Blue colorant: C.I. pigment blue 15:6/C.I. pigment violet 23/dispersion agent (B-1) Binder: a ratio of methyl(metha)acrylic acid unit and benzylmethyl(metha)acrylate unit [methyl(metha)acrylic acid/benzylmethyl(metha)acrylate copolymer) is 30:70 by mole ratio, an acid value is 113, and polystyrene reduced weight average molecular weight is 25,000] (C-1) Polymerizable compound: polyfunctional oxetane compound [OXT-221 (manufactured by Donga Synthetics. Co., Ltd.)] (D-1) Polymerization initiator: N-benzylpyrazinium hexafluoro antimonate (E-1) Solvent: propylene glycol monomethyl ether acetate (PGMEA) (E-2) Solvent: ethyl-3-ethoxy propionate (EEP) *110(E-3) Solvent: dipropylene glycol monomethyl ether acetate (DPMA) (F-1) surfactant: SH8400 (manufactured by Torey Silicon Co., Ltd.) By changing the amount ratio of the above ingredients as shown below, ink compositions 1 to 6 according to exemplary embodiments of the present invention and ink compositions 7 to 9 of comparative examples were prepared.

TABLE 1

| No. | A-1 | A-2 | A-3 | B-1 | C-1 | D-1 | E-1 | E-2 | E-3 | F-1 |
|---|---|---|---|---|---|---|---|---|---|---|
| 1 | 13.00 | | | 5.30 | 1.48 | 0.21 | 70.97 | 9.03 | | 0.01 |
| 2 | | 15.79 | | 3.98 | 3.70 | 0.44 | 67.50 | 8.58 | | 0.01 |
| 3 | | | 14.06 | 7.80 | 1.90 | 0.23 | 68.40 | 7.60 | | 0.01 |
| 4 | 15.23 | | | 4.34 | 7.74 | 0.93 | 63.73 | 8.02 | | 0.01 |
| 5 | | 16.17 | | 6.12 | 6.20 | 1.49 | 70.01 | | | 0.01 |
| 6 | | | 10.72 | 5.00 | 9.42 | 1.13 | 73.72 | | | 0.01 |
| 7 | 15.18 | | | 3.98 | 7.98 | 0.96 | | | 71.89 | 0.01 |
| 8 | | 15.60 | | 4.70 | 5.07 | 0.61 | | | 74.01 | 0.01 |
| 9 | | | 10.85 | 4.89 | 9.79 | 1.17 | | | 73.29 | 0.01 |

*unit: wt %

As shown in Table 1, the exemplary ink compositions 1 to 6 according to the present invention contain propylene glycol monomethyl ether acetate (PGMEA) with a boiling point of about 150° C. or lower as a main solvent, while the compositions 7 to 9 according to the comparative examples contain dipropylene glycol monomethyl ether acetate (“DPMA”) with a boiling point higher than about 150° C.

The ink jet composition 1 to 6 according to the present invention and the compositions 7 to 9 according to the comparative examples as shown in Table 1 were sprayed onto a substrate with a size of 370 mm×470 mm with partitions formed by the light blocking members, respectively. Viscosity of the exemplary ink compositions 1 to 6 according to the present invention and the compositions 7 to 9 according to the comparative examples was measured to obtain results as shown in Table 2.

TABLE 2

| | Ratio of solvent (%) | | | |
|---|---|---|---|---|
| | E-1 | E-2 | E-3 | Viscosity (mPa · s) |
| 1 | 89 | 11 | | 8.4 |
| 2 | 89 | 11 | | 6.2 |
| 3 | 90 | 10 | | 6.5 |
| 4 | 89 | 11 | | 9.9 |
| 5 | 100 | | | 9.0 |
| 6 | 100 | | | 10.3 |
| 7 | | | 100 | 13.2 |
| 8 | | | 100 | 12.9 |
| 9 | | | 100 | 13.6 |

In Table 2, viscosity was measured by using an R-type viscometer (‘VISCOMETER MODEL RE120L SYSTEM’ manufactured by Tokey Sankyo, Co., Ltd., the number of rotations was 20 rpm and the temperature was about 25° C.), and the measurement unit is mPa·s. In Table 2, it is noted that the ink composition including the solvent (E-1) with the boiling point of about 150° C. or lower has a lower viscosity compared with the ink composition including the solvent (E-3) with a relatively higher boiling point.

Likewise, a jetting characteristic, an overflow and flatness were checked with respect to the exemplary ink compositions 1 to 6 according to the present invention, and the compositions 7 to 9 according to the comparative examples. Table 3 shows the results.

TABLE 3

| | Pixel size (longer axis: | | | Pixel size | | |
|---|---|---|---|---|---|---|
| | 200 μm~300 μm) | | | (longer axis: 450 μm~550 μm) | | |
| | Jetting | Over- | Flat- | Jetting | | Flat- |
| | characteristics | flow | ness | characteristics | Overflow | ness |
| 1 | ◯ | ◯ | ◯ | ◯ | Δ | Δ |
| 2 | ◯ | ◯ | ◯ | ◯ | Δ | Δ |
| 3 | ◯ | ◯ | ◯ | ◯ | Δ | Δ |
| 4 | ◯ | ◯ | Δ | ◯ | ◯ | ◯ |
| 5 | ◯ | ◯ | Δ | ◯ | ◯ | ◯ |
| 6 | ◯ | ◯ | Δ | ◯ | ◯ | ◯ |
| 7 | ◯ | ◯ | X | ◯ | ◯ | X |
| 8 | ◯ | ◯ | X | ◯ | ◯ | X |
| 9 | ◯ | ◯ | X | ◯ | ◯ | X |

In Table 3, the jetting characteristic of the ink was evaluated using ink jet drop analyzing equipment. Herein, ‘◯’ indicates that the ink jet nozzle was not clogged and the sprayed ink drops appeared as a straight line in its intended direction, ‘Δ’ indicates that the ink jet nozzle was not clogged but the sprayed ink drops did not appear as a straight line in its intended direction, and ‘X’ indicates that the ink jet nozzle was clogged.

As noted in Table 3, the ink compositions according to the present invention and the comparative examples show that the ink jet nozzle were not clogged and the sprayed ink drops were straight lines sprayed in its intended direction. This means that although the ink composition according to the present invention uses the solvent with the low boiling point, because the ink remnant at an entrance of the ink jet head forms an air inflow preventing layer by itself, the same level of jetting characteristic as that obtained by using the solvent with a high boiling point can be obtained.

In Table 3, the overflow phenomenon of the ink was evaluated using Keyence-VF-7510 (manufactured by Keyence Co.). Herein, ‘◯’ indicates that ink was sprayed onto the accurate position while not causing an adjacent pixel to be a mixed color pixel, and color filters with a desired thickness were formed in the pixel, ‘Δ’ indicates that ink was sprayed onto the accurate position but there was a remnant of ink on the partitions, failing to form color filters with the desired thickness, and ‘X’ indicates that ink was sprayed onto an adjacent pixel causing a mixed color pixel.

Accordingly, as noted in Table 3, the ink compositions according to the present invention and the compositions according to the comparative examples were sprayed onto the accurate positions, and the color filters were formed with the desired thickness.

In addition, in Table 3, as for the flatness, color filters formed by drying the above-described ink compositions in an oven were evaluated using Keyence-VF-7510 (manufactured by Keyence Co.) and Dektak3ST (manufactured by Veeco Co.). Herein, ‘◯’ indicates a case where a difference of the color filter thickness was smaller than 0.05 μm, ‘Δ’ indicates a case where the difference of the color filter thickness was 0.05 μm to 0.3 μm, and ‘×’ indicates a case where the difference of the color filter thickness was greater than 0.3 μm. As shown in Table 3, it is noted that the exemplary ink compositions according to the present invention exhibit better flatness compared with the compositions according to the comparative examples.

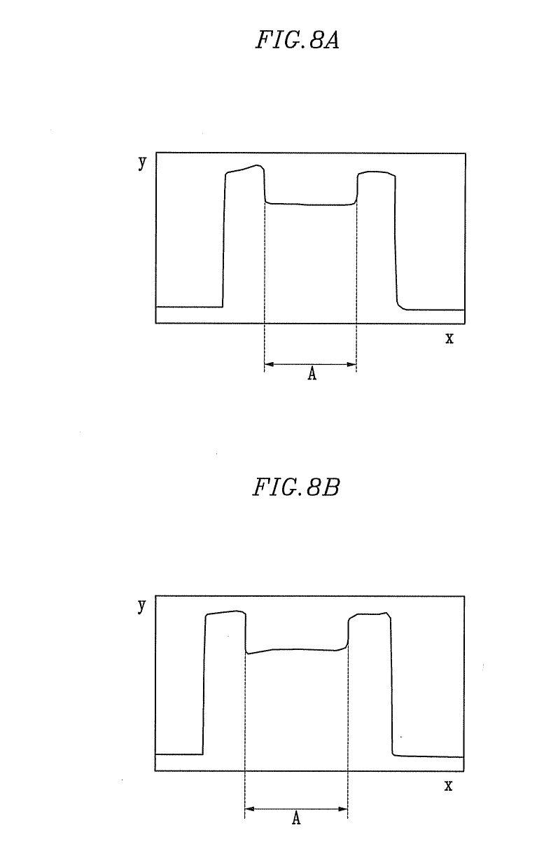

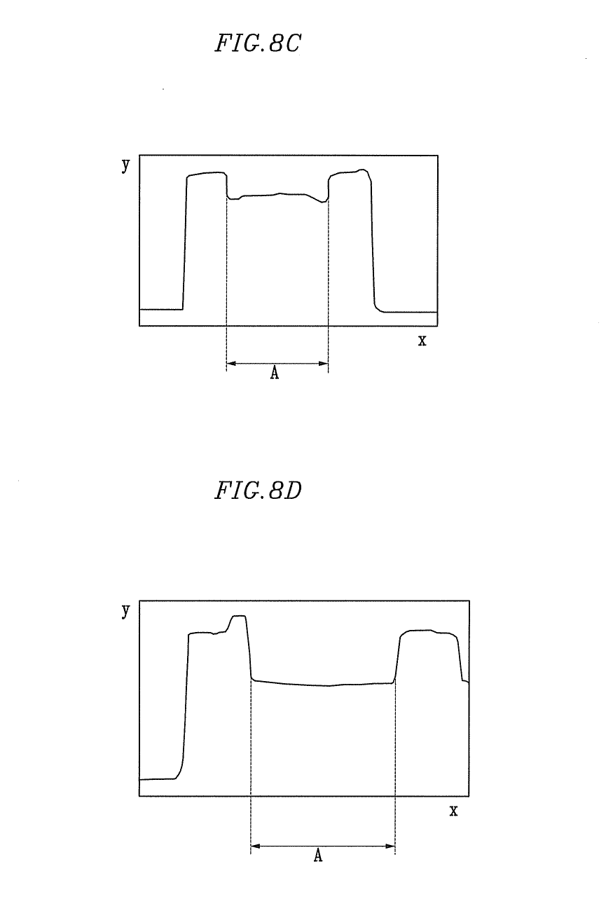

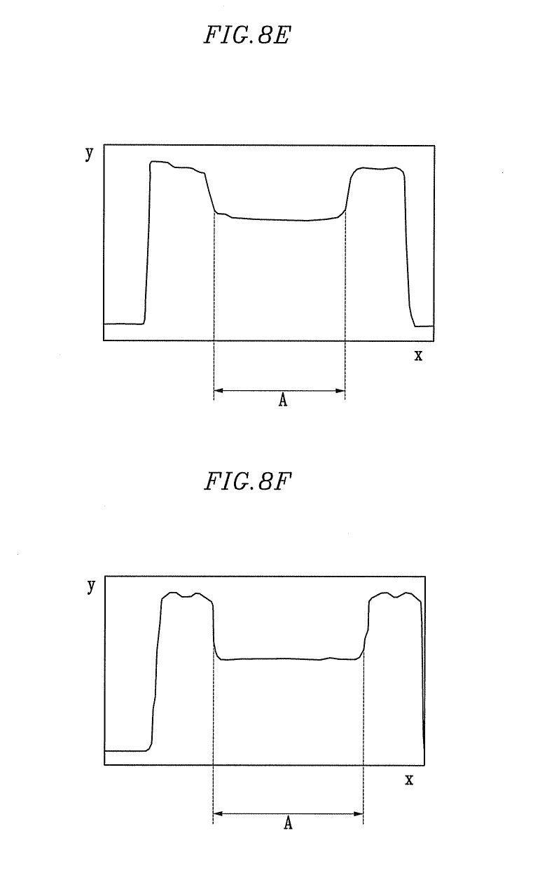

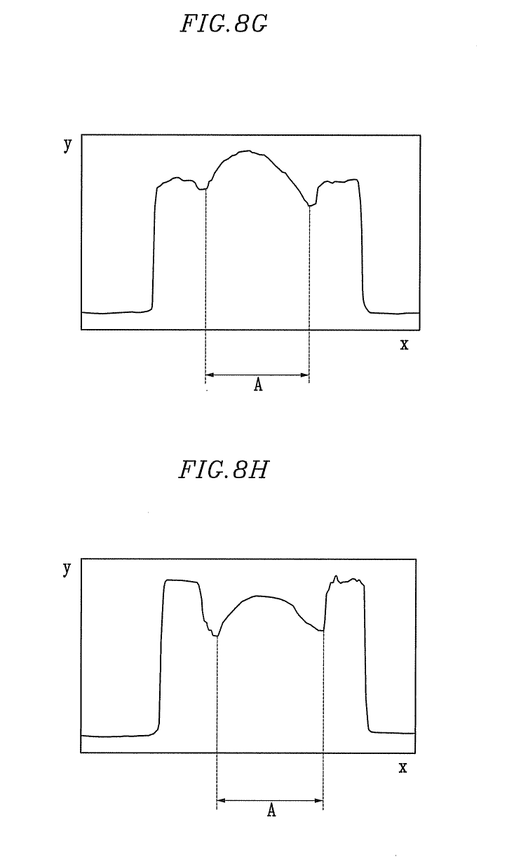

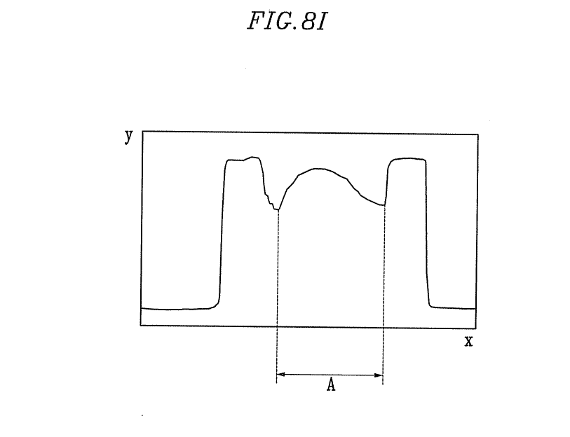

The flatness results can also be confirmed through FIGS. 8A to 8F. FIGS. 8A to 8C are graphs showing the results obtained by measuring the flatness of the color filters (ink compositions 1 to 3) formed in a pixel with a longer axis size of about 250 μm, FIGS. 8D to 8F are graphs showing the results obtained by measuring the flatness of the color filters (ink compositions 4 to 6) formed in a pixel with a longer axis size of about 500 μm, and FIGS. 8G to 8I are graphs showing the results obtained by measuring the flatness of the color filters (comparative examples 7 to 9) formed in a pixel with a longer axis size of about 250 μm.

In FIGS. 8A to 8I, the x axis indicates distance and the y axis indicates thickness. ‘A’ is a central portion of a color filter, and both sides of ‘A’ are edge portions on either side of the central portion ‘A’ that define the color filter. The more uniform the thickness of the portion ‘A’ (y axis becomes uniform), the better the flatness of the color filters.

The ink compositions according to the present invention as shown in FIGS. 8A to 8F form the color filters with a relatively uniform thickness, having good flatness, whereas the compositions according to the comparative examples as shown in FIGS. 8G to 8I form a thick central portion in a spherical shape, have poor flatness. Thus, it can be recognized that the flatness of the color filters using the solvent with the low boiling point is superior.

As described above, by using the ink compositions according to the present invention, thin color filters can be formed with excellent flatness, and because the difference of thickness between the central portion and the edge portions of the color filters can be reduced, thus preventing a defective viewing angle or light leakage. In addition, because the ink remnant around the discharge hole of the ink jet nozzles forms an air inflow preventing layer by itself, air can be prevented from flowing into the nozzles, and thus the ink spraying force can be improved.

While the present invention has been described in connection with what is presently considered to be practical exemplary embodiments, it is to be understood that the present invention is not limited to the disclosed exemplary embodiments, but, on the contrary, is intended to cover various modifications and equivalent arrangements included within the spirit and scope of the appended claims.

What is claimed is:

1. An ink composition comprising:
a polymerizable compound, a polymerization initiator, a binder, a colorant, and
a solvent comprising at least one main solvent with a boiling point of about 150° C. or lower.

2. The composition of claim 1, wherein the main solvent is contained at about 80 wt % or more of the total amount of the solvent.

3. The composition of claim 1, wherein the main solvent comprises at least one of n-butyl acetate, isobutyl acetate, isoamyl acetate, n-amyl acetate, methyl isobutyl ketone, n-butyl alcohol, ethylene glycol ethyl ether, ethylene glycol monomethyl, ethylene glycol ether, ethylene glycol propyl ether, ethylene glycol isopropyl ether, ethylene glycol monomethyl ether acetate, ethylene glycol ethyl ether acetate, propylene glycol monomethyl ether, propylene glycol monomethyl ether, propylene glycol ethyl ether, propylene glycol propyl ether, propylene glycol monomethyl ether acetate, N,N-dimethyl formamide, o-xylene, and m-xylene.

4. The composition of claim 1, wherein vapor pressure of the main solvent is about 2 mmHg or higher at room temperature.

5. The composition of claim 1, further comprising an auxiliary solvent at about 20 wt % or less of the total amount of the solvent.

6. The composition of claim 5, wherein the auxiliary solvent comprises at least one selected from ethyl-3-ethoxy propionate (EEP) or propylene glycol monomethyl ether acetate (DPMA).

7. The composition of claim 1, wherein the solvent is contained at about 40 to about 90 wt % of the total amount of the ink composition.

8. The composition of claim 1, comprising a polymerizable compound at about 0.1 wt % to about 50 wt %, a polymerization initiator at about 0.1 wt % to about 20 wt %, a binder at about 0.1 wt % to about 50 wt %, and a colorant at about 30 wt % to about 80 wt % with respect to a solid of the total amount of the ink composition.

9. The composition of claim 1, further comprising at least one additive.

10. The composition of claim 9, wherein the additive is contained at about 0.001 wt % to about 10 wt % of the total amount of the ink composition.

11. A display panel comprising:
a substrate;
color filters formed on the substrate; and
field-generating electrodes formed on the color filters,
wherein the color filters are formed of an ink composition containing a polymerizable compound, a polymerization initiator, a binder, a colorant, and a solvent comprising at least one main solvent with a boiling point of about 150° C. or lower.

12. The panel of claim 11, wherein the color filters have a thickness of about 1.5 μm or less.

13. The panel of claim 11, wherein the color filters have color reproducibility of about 55% or more.

14. The panel of claim 11, further comprising partitions defining the color filters.

15. The panel of claim 11, wherein the main solvent comprises at least one of n-butyl acetate, isobutyl acetate, isoamyl acetate, n-amyl acetate, methyl isobutyl ketone, n-butyl alcohol, ethylene glycol ethyl ether, ethylene glycol monomethyl, ethylene glycol ether, ethylene glycol propyl ether, ethylene glycol isopropyl ether, ethylene glycol monomethyl ether acetate, ethylene glycol ethyl ether acetate, propylene glycol monomethyl ether, propylene glycol monomethyl ether, propylene glycol ethyl ether, propylene glycol propyl ether, propylene glycol monomethyl ether acetate, N,N-dimethyl formamide, o-xylene, and m-xylene, and the main solvent is contained at about 80 wt % or greater with respect to the total amount of the solvent.

16. The panel of claim 11, wherein the solvent is contained at about 40 wt % to about 90 wt % with respect to the total amount of the ink composition.

17. The panel of claim 11, wherein the display panel contains a polymerizable compound at about 0.1 wt % to about 50 wt %, a polymerization initiator at about 0.1 wt % to about 20 wt %, a binder at about 0.1 wt % to about 50 wt %, and a colorant at about 30 wt % to about 80 wt %, with respect to the total amount of a solid of the ink composition.

18. A display panel comprising:
a substrate,
color filters formed on the substrate, the color filters having a thickness of about 1.5 μm or less; and
field-generating electrodes formed on the color filters.

19. The panel of claim 18, wherein the color filters have color reproducibility of about 55% or more.

20. The panel of claim 18, wherein the color filters are formed of an ink composition containing a polymerizable compound, a polymerization initiator, a binder, a colorant, and a solvent comprising at least one main solvent with a boiling point of about 150° C. or lower.

21. A method for manufacturing a display panel, comprising:
forming partitions with a plurality of openings on a substrate;
preparing an ink composition containing a polymerizable compound, a polymerization initiator, a binder, a colorant, and a solvent comprising at least one main solvent with a boiling point of about 150° C. or lower;
spraying the ink composition in the openings;
drying the ink composition to form color filters; and
forming field-generating electrodes on the color filters.

22. The method of claim 21, wherein the main solvent comprises at least one of n-butyl acetate, isobutyl acetate, isoamyl acetate, n-amyl acetate, methyl isobutyl ketone, n-butyl alcohol, ethylene glycol ethyl ether, ethylene glycol monomethyl, ethylene glycol ether, ethylene glycol propyl ether, ethylene glycol isopropyl ether, ethylene glycol monomethyl ether acetate, ethylene glycol ethyl ether acetate, propylene glycol monomethyl ether, propylene glycol monomethyl ether, propylene glycol ethyl ether, propylene glycol propyl ether, propylene glycol monomethyl ether acetate, N,N-dimethyl formamide, o-xylene, and m-xylene, and the main solvent is contained at about 80 wt % or greater with respect to the total amount of the solvent.

23. The method of claim 21, wherein the solvent may be contained at about 40 wt % to about 90 wt % with respect to the total amount of the ink composition.

24. The method of claim 21, wherein the display panel contains a polymerizable compound at about 0.1 wt % to about 50 wt %, a polymerization initiator at about 0.1 wt % to about 20 wt %, a binder at about 0.1 wt % to about 50 wt %, and a colorant at about 30 wt % to about 80 wt % with respect to the total amount of a solid of the ink composition.
